(19) United States
(12) Patent Application Publication
(10) Pub. No.: US 2026/0358231 A1
(43) Pub. Date: Nov. 12, 2026

(54) IONIZATION FLUORESCENCE SENSORS FOR DETECTING PARTICLES

(71) Applicant: University of Utah Research Foundation, Salt Lake City, UT (US)

(72) Inventor: Massood TABIB-AZAR, Salt Lake City, UT (US)

(21) Appl. No.: 19/125,658

(22) PCT Filed: Oct. 31, 2023
(86) PCT No.: PCT/US2023/036476

§ 371 Date: Apr. 29, 2025

Related U.S. Application Data
(60) Provisional application No. 63/421,071, filed on Oct. 31, 2022.

(51) Int. Cl. G01N 15/1434; G01N 15/00; G01N 15/01; G01N 15/10

(52) U.S. Cl. CPC G01N 15/1434; G01N 15/01; G01N 2015/0038; G01N 2015/1028

(57) ABSTRACT

A sensor (100) for detecting airborne substances can include an ionization chamber (110). This ionization chamber (110) can be adapted to accept a fluid sample (102) that includes a particle (104) to be detected. An energy source (120) can also be adapted provide sufficient energy to the particle (104) to ionize the particle (104) and at least partially decompose the particle (104). A light sensor (130) can be adapted to detect a characteristic light emission from the ionized particle. When using the sensor (100), the light emission from the ionized particle can be detected and then correlated with a known characteristic light emission of the target particle (104). The sensor (100) can also indicate and identify the presence of the particle (104) in the fluid, sample (102).

### CROSS REFERENCE TO RELATED APPLICATIONS

This application claims priority to U.S. Provisional Application No. 63/421,071, filed Oct. 31, 2022, which is incorporated herein by reference.

### STATEMENT REGARDING FEDERALLY SPONSORED RESEARCH OR DEVELOPMENT

This invention was made with government support under grant 2030359 awarded by the National Science Foundation. The government has certain rights in this invention.

### NAMES OF THE PARTIES TO A JOINT RESEARCH AGREEMENT

Not applicable.

### INCORPORATION BY REFERENCE STATEMENT

Not applicable.

### BACKGROUND

Detection of small particles can be challenging. For example, detection of airborne particles on the order of nanometers in size can be difficult, especially when the particles are present at very low concentrations. Laser scattering is one method that has been used to detect particles larger than about 1 micron. However, this method is not capable of distinguishing between particles of different materials, only particles of differing sizes. Raman spectroscopy is an example method that has been used to detect specific chemical compounds. In Raman spectroscopy, a sample is illuminated with photons, such as from a laser, and the photons interact with molecular vibrations, phonons, and other excitations of the sample which are compositionally unique responses and which can shift the energy of the emitted photons up or down through Raman scattering. The emitted photon energy can be used to identify molecules in the sample. Other spectroscopic techniques have also been used to analyze materials, such as infrared spectroscopy, mass spectroscopy, X-ray fluorescent spectroscopy, etc.

### SUMMARY

This invention relates to methods of detecting particles using ionization and fluorescence. Particles in a sample can be ionized by inputting a sufficient amount of energy to the sample. This can also cause disintegration of the particles. The ionization and disintegration process can result in a unique light emission spectrum from fluorescence of the ionized species. The spectrum can be correlated with particular materials, such as viruses, toxic molecules, nanoparticles, or any other particle to be identified.

In one example, a sensor for detecting a particle can include an ionization chamber adapted to accept a fluid sample comprising a particle to be detected. The sensor can also include an energy source adapted to provide sufficient energy to the particle to ionize the particle and at least partially decompose the particle A light sensor can be adapted to detect a characteristic light emission from the ionized particle.

An example method of detecting a particle can include applying energy to a fluid sample comprising a particle to be detected. The energy can be sufficient to ionize the particle and at least partially decompose the particle. A light emission from the ionized particle can be detected and analyzed to identify the ionized particle. The detected light emission can be correlated with a characteristic light emission of the particle. The method can also include indicating the presence of the particle in the fluid sample.

There has thus been outlined, rather broadly, the more important features of the invention so that the detailed description thereof that follows may be better understood, and so that the present contribution to the art may be better appreciated. Other features of the present invention will become clearer from the following detailed description of the invention, taken with the accompanying drawings and claims, or may be learned by the practice of the invention.

### BRIEF DESCRIPTION OF THE DRAWINGS

FIG. 1 is a schematic illustration of an example sensor for detecting particles in accordance with examples of the present disclosure.

FIG. 2 is a schematic illustration of another example sensor for detecting particles in accordance with examples of the present disclosure.

FIG. 3 is a schematic illustration of another example sensor for detecting particles in accordance with examples of the present disclosure.

FIG. 4 is a schematic illustration of an example plasma generator in accordance with examples of the present disclosure.

FIG. 5 is a schematic illustration of another example plasma generator in accordance with examples of the present disclosure.

FIG. 6 is a schematic illustration of another example plasma generator in accordance with examples of the present disclosure.

FIG. 7 is a schematic illustration of yet another example plasma generator in accordance with examples of the present disclosure.

FIG. 8 is a schematic illustration of another example sensor for detecting particles in accordance with examples of the present disclosure.

FIG. 9 is a schematic illustration of another example sensor for detecting particles in accordance with examples of the present disclosure.

FIGS. 10A-10C are schematic illustrations of particle sample concentrators in accordance with examples of the present disclosure.

FIG. 11 is a perspective view of another example sensor for detecting particles in accordance with examples of the present disclosure.

FIG. 12 is a schematic illustration of electrodes connected to capillary tubes for use in an example sensor for detecting particles in accordance with examples of the present disclosure.

FIG. 13A is a schematic illustration of an example MEMS mass spectrometer used with an example sensor for detecting particles in accordance with examples of the present disclosure.

FIG. 13B is a cross-sectional view of an example MEMS mass spectrometer in accordance with examples of the present disclosure.

FIG. 14 is a normalized plot of emission spectra contribution of water.

FIG. 15 is a normalized plot of emission spectra of potassium chloride, sodium chloride, and water.

FIG. 16 shows normalized plots of emission spectra of guanine, adenine, cytosine, and thymine solutions. Adenine, cytosine, and thymine plots were given an offset of +0 2, +0.4, and +0.6 respectively.

FIG. 17 shows normalized emission spectra of adenine solutions with 0.0025 g/1 mL (1×), 0.005 g/l mL (2×), and 0.01 g/l mL (4×) concentrations.

FIG. 18 shows normalized plots of emission spectra of different concentrations 0.0025 g/1 mL (1×), 0.005 g/1 mL (2×), and 0.01 g/1 mL (4×) of cytosine solutions between 300-500 nm.

FIG. 19 is a graph of emission peaks at 439.5 for adenine, 440.5 for cytosine and thymine, and 421.5 for guanine as a function of their concentrations.

FIG. 20 shows normalized emission spectra of fresh saliva before eating, five-minutes after eating, and within sixty-minutes of eating.

FIG. 21 shows a normalized emission spectra of uninfected and infected saliva.

FIG. 22 shows normalized emission spectra of several types of airborne inorganic particles.

FIG. 23 shows emission spectra of Influenza A and SARS-CoV-2 viruses.

FIG. 24 shows emission spectra of a dry gold electrode and saliva.

FIG. 25 shows emission spectra of acetone and isopropyl alcohol.

FIG. 26 shows emission spectra of saliva samples having different viral loads.

FIG. 27 shows emission spectra of two saliva samples.

FIG. 28 shows emission spectra of water, isopropyl alcohol, and acetone.

These drawings are provided to illustrate various aspects of the invention and are not intended to be limiting of the scope in terms of dimensions, materials, configurations, arrangements or proportions unless otherwise limited by the claims.

### DETAILED DESCRIPTION

While these exemplary embodiments are described in sufficient detail to enable those skilled in the art to practice the invention, it should be understood that other embodiments may be realized and that various changes to the invention may be made without departing from the spirit and scope of the present invention. Thus, the following more detailed description of the embodiments of the present invention is not intended to limit the scope of the invention, as claimed, but is presented for purposes of illustration only and not limitation to describe the features and characteristics of the present invention, to set forth the best mode of operation of the invention, and to sufficiently enable one skilled in the art to practice the invention. Accordingly, the scope of the present invention is to be defined solely by the appended claims.

### DEFINITIONS

In describing and claiming the present invention, the following terminology will be used.

The singular forms “a,” “an,” and “the” include plural referents unless the context clearly dictates otherwise. Thus, for example, reference to “a pathogen” includes reference to one or more of such materials and reference to “the electrode” refers to one or more of such electrodes.

As used herein with respect to an identified property or circumstance, “substantially” refers to a degree of deviation that is sufficiently small so as to not measurably detract from the identified property or circumstance. The exact degree of deviation allowable may in some cases depend on the specific context.

As used herein, “adjacent” refers to the proximity of two structures or elements. Particularly, elements that are identified as being “adjacent” may be either abutting or connected. Such elements may also be near or close to each other without necessarily contacting each other. The exact degree of proximity may in some cases depend on the specific context.

As used herein, the term “about” is used to provide flexibility and imprecision associated with a given term, metric or value. The degree of flexibility for a particular variable can be readily determined by one skilled in the art. However, unless otherwise enunciated, the term “about” generally connotes flexibility of less than 2%, and most often less than 1%, and in some cases less than 0.01%.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

As used herein, the term “at least one of” is intended to be synonymous with “one or more of.” For example, “at least one of A, B and C” explicitly includes only A, only B, only C, or combinations of each.

Numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a numerical range of about 1 to about 4.5 should be interpreted to include not only the explicitly recited limits of 1 to about 4.5, but also to include individual numerals such as 2, 3, 4, and sub-ranges such as 1 to 3, 2 to 4, etc. The same principle applies to ranges reciting only one numerical value, such as “less than about 4.5,” which should be interpreted to include all of the above-recited values and ranges. Further, such an interpretation should apply regardless of the breadth of the range or the characteristic being described.

Any steps recited in any method or process claims may be executed in any order and are not limited to the order presented in the claims. Means-plus-function or step-plus-function limitations will only be employed where for a specific claim limitation all of the following conditions are present in that limitation: a) “means for” or “step for” is expressly recited; and b) a corresponding function is expressly recited. The structure, material or acts that support the means-plus function are expressly recited in the description herein. Accordingly, the scope of the invention should be determined solely by the appended claims and their legal equivalents, rather than by the descriptions and examples given herein.

### Ionization Fluorescence Sensors for Detecting Particles

The sensors described herein can be used to detect and identify a wide variety of particles. Some examples of particles include viruses, bacteria, pathogens, toxic compounds, nanoparticles, and others. The sensors can apply sufficient energy to the particles to ionize the particles and at least partially decompose the particles. The energy can be applied in a variety of ways. In some examples, the energy can be applied using a plasma generator that can partially or fully ionize the particles. Further methods of applying energy can include radio frequency (RF), microwaves, direct current (DC), alternating current (AC), high-frequency electromagnetic radiation, ultraviolet (UV), X-ray, laser, flame, electron beam, and others. Multiple different energy sources can be used together in some examples. In one specific example, the energy source can be a high-power laser diode.

As mentioned above, the energy applied to the particles can be sufficient to ionize the particles and at least partially decompose the particles. For example, applying plasma to the particles can convert the particles into plasma, in which state at least a portion of the particles can be ionized and the ionized particles can emit light. The light emitted by ionized particles can have a different spectral signature depending on the materials from which the particles are made. The specific spectral signature that is emitted can be a characteristic light emission that can be used to identify the particle. This can be useful, for example, for detecting the presence of a specific type of virus or bacteria. Certain viruses can emit a specific combination of wavelengths of light at certain intensity levels. Therefore, if the characteristic light emission is detected then this can indicate that particles are present in a sample and that the particles are the specific type of particle that the sensor is designed to recognize. In some examples, the target particle can emit certain peak wavelengths and the detecting of these specific peaks in a spectrum can indicate the presence of the target particle. Additionally, the emitted light from the target particles can be more intense when the concentration of the target particle higher. Therefore, the amplitude of the peaks can be used to calculate the concentration of the target particle.

In some examples, the particles can be at least partially decomposed by the application of energy. This decomposition can include the particles breaking down into smaller particles, chemically reacting, vaporizing, or a combination thereof. The decomposition products can also be ionized and they can also emit light at certain wavelengths. For a given type of particle, the characteristic light emission, or spectral signature, indicating the presence of the particle can include the light emitted by decomposition products. The decomposition products can include smaller particles, individual molecules that are released from the particle, chemical reaction products of compounds in the particle reacting with each other or with air, and others products in various examples. Thus, the overall characteristic light emission of a particle such as a virus can include light emitted by the entire ionized particle combined with light emitted by various ionized decomposition products of the particle. The plasma-induced fluorescent spectra (PIF) depends on the intensity and type of plasma that is used. For a given plasma generation method (DC, RF, capacitively coupled, inductively coupled, etc.) the PIF is nearly constant and it only fluctuates as the particles are brought into the ionization chamber and the fluctuation of the current. Therefore, the correlation can account for these variables as well.

Light emission spectra can be collected across wavelength and intensity. These spectra can then be correlated with spectra of known reference materials to identify the type of particle from which these ionization spectra were produced. The spectra can also be a function of intensity of ionization, the motion of particles through the ionization chamber, background gases (CO₂, humidity, etc.) and the like. A suitable data processor can be used to compare such spectra to known reference spectra. The data processing tasks are consistent with spectra analysis methods that are developed and used in Raman and other spectroscopies.

The sensors described herein can be particularly useful for detecting hazardous particles such as viruses, bacteria, other pathogens, toxic compounds, and so on. The sensor can ionize and decompose the particles, which can render these hazardous materials safer in some examples. For example, a virus can be ionized and decomposed to non-infectious decomposition products. In certain examples, the sensor can form oxygen plasma from ambient air and the oxygen plasma can react with various molecules in a virus to form oxidized products. The virus can decompose completely into benign products, such as CO₂ and H₂O. Thus, the measurement process can disintegrate any pathogens and viruses in the sample. Additionally, the measurement can be very fast and suitable for sampling air in large arenas or other public buildings. For example, the sensors described herein can be incorporated into air handling systems of such buildings. The sensors can provide nearly real-time information about the presence of viruses and other particles and their concentrations. As an example, preliminary results show that the sensors can differentiate between SARS-COV-2 and Influenza A viruses.

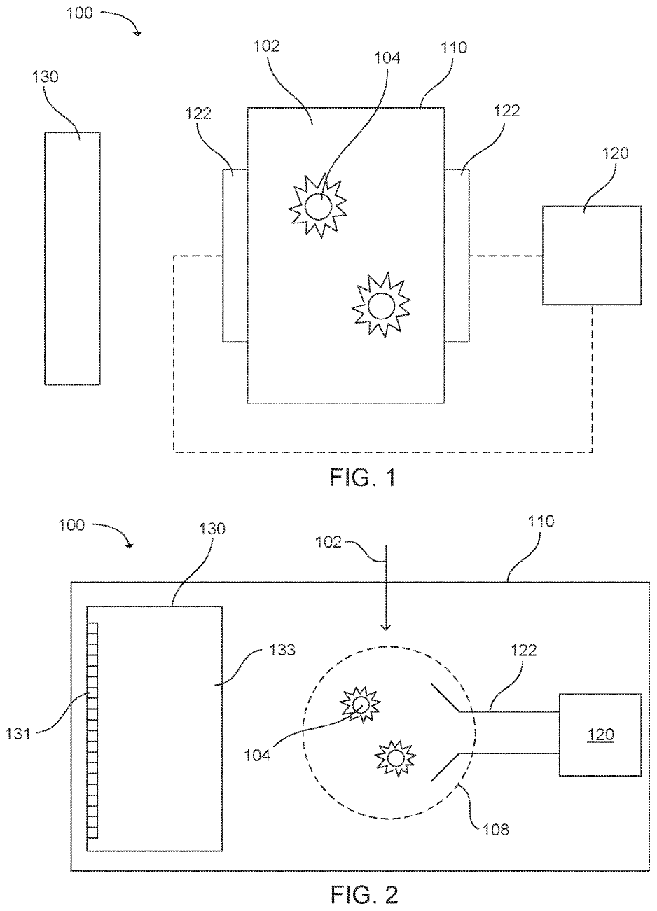

With this description in mind, FIG. 1 is a schematic drawing of an example sensor 100 for detecting particles. The sensor includes an ionization chamber 110 adapted to accept a fluid sample 102 that contains particles 104 to be detected. An energy source 120 is adapted to provide sufficient energy to the particles within the ionization chamber to ionize the particles and at least partially decompose the particles. In this example, the energy source is an RF plasma generator connected to electrodes 122 that are positioned to generate plasma within the ionization chamber. The ionized particles can emit light of certain wavelengths. A light sensor 130 can be adapted to detect the light emitted by the ionized particles. In this example, the light sensor is an optical spectrometer that can measure the intensity of different wavelengths of light. The emitted light can have a characteristic spectral signature that allows the particles to be identified. The characteristic light emission can be detected by the light sensor and then correlated with known characteristic light emissions of particles to be detected in order to identify the particles.

FIG. 2 is a schematic drawing of another example sensor 100 for detecting particles. In this example, the ionization chamber 110 is larger and encompass the other components of the sensor. A fluid sample 102 (which is an airflow in this example) flows into the sensor. An energy source 120 is connected to electrodes 122 positioned to generate plasma within a plasma volume 108, represented by a dashed circle. A light sensor 130 includes a detector array 131 and a lens 133. Ionized particles 104 generate light that is detected by the detector array.

The sensor can include at least one energy source which inputs a sufficient amount of energy to ionize and at least partially disintegrate any particles present in a sample. A variety of energy sources can be used to ionize and decompose the particles in the sensors described herein. Any energy source or combination of energy sources that is sufficient to ionize and at least partially decompose the particles can be used. In various examples, the energy source can include a radio frequency (RF) source, a microwave source, a direct current (DC) source, an alternating current (AC) source, a plasma generator, a high-frequency electromagnetic source, an ultraviolet (UV) source, an X-ray source, a laser, a flame, an electron beam, or a combination thereof. In some examples, the energy source can include a source of electromagnetic radiation that is infrared or higher energy (i.e., shorter wavelengths). The electromagnetic radiation source can emit radiation with a wavelength from about 1 mm to about 0.03 nm, or from about 3,000 nm to about 0.03 nm, or from about 750 nm to about 0.03 nm, or from about 700 nm to about 0.03 nm, or from about 700 nm to about 1 nm, or from about 700 nm to about 100 nm, or from about 700 nm to about 400 nm.

In certain examples, the energy source can be configured to generate plasma in the ionization chamber. The plasma can include oxygen plasma and nitrogen plasma formed from ambient air, along with plasma formed by ionizing any particles in the air. The energy source can include a plasma generator such as a capacitively coupled plasma generator, an inductively coupled plasma generator, a dielectric barrier discharge plasma generator, an alternating current (AC) plasma generator, a direct current (DC) plasma generator, a radio frequency (RF) plasma generator, or a combination thereof. In certain examples, a capacitively coupled plasma generator can include two electrodes separated by a gap, and plasma can form in the gap when a sufficient electric voltage is applied to the electrodes. The gap can be at least partially within the ionization chamber of the sensor. In other examples, an inductively couple plasma generator can include a coil such as a planar spiral coil, a helical coil, or a toroidal coil.

In one example, oxygen plasma and nitrogen plasma can be generated using a dielectric barrier RF resonant ionizer operating at 13.56 MHz. The ionizer power scales with the air volume and can range from about 10 mW to hundreds of Watts. In another example, RF power of 10-20 mW at 600 MHz can be used. In various examples, plasma generators used in the sensors can have a power level from about 1 mW to about 1,000 W depending on the plasma generation method, the volume of plasma ionization chamber, air flow rate, particle density, and background gases (CO₂, humidity, etc.), or from about 10 mW to about 100 W, or from about 1 mW to about 10 W, or from about 10 mW to about 1 W, or from about 10 mW to about 500 mW, or from about 10 mW to about 100 mW, or from about 10 mW to about 50 mW, or from about 1 W to about 1,000 W, or from about 10 W to about 1,000 W, or from about 100 W to about 1,000 W. In further examples, the other types of energy sources mentioned above can also have power levels in these ranges.

A combination of multiple different energy sources can be used in some examples. In one example, the energy source can include a DC field as a bond stretching action with a supplemental AC (e.g. RF) source to oscillate bonds sufficient to cause disintegration. A DC field alone of about 1.000V can be used to cause disintegration. Adding AC can allow reduction of this voltage to about 100 V to 200 V. A supplemental energy source can also be added, such as a laser (e.g. a green or blue laser) depending on alignment with the resonance of the target materials. In several examples, an electric field greater than about 10⁵ V/cm can be sufficient to ionize target particles. In various examples, the energy source can generate an electric field from about 10³ V/cm to about 10⁸, V/cm, or from about 10⁵ V/cm to about 10⁸ V/cm, or from about 10⁵ V/cm to about 10⁸ V/cm, or from about 10⁵ V/cm to about 10⁷ V/cm, or from about 10⁵ V/cm to about 10⁶ V/cm.

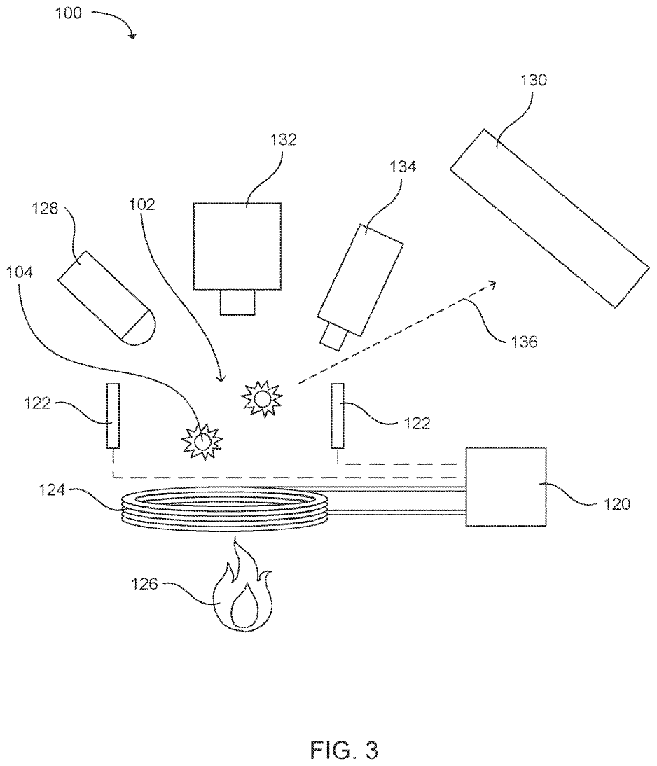

FIG. 3 is a schematic illustration of an example sensor 100 that includes multiple energy sources that can be used in combination. The energy sources include an RF source 120, electrodes 122 for capacitively coupled plasma generation, a coil 124 for inductively coupled plasma generation, a flame 126 that can heat the particles 104 in the sample 102, a laser 128, an X-ray emitter 132, and an electron beam (E-beam) emitter 134. Any of the energy sources can be used alone or in combination. This sensor also includes a spectrometer 130 positioned to receive light 136 emitted by the ionized particles.

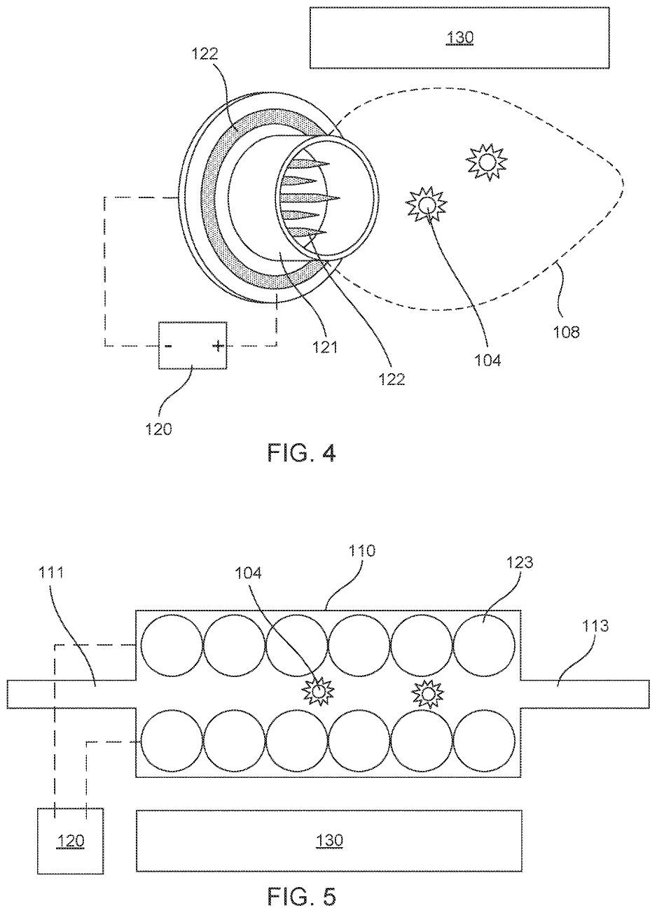

Further examples can include a variety of different plasma generators. FIG. 4 is a schematic illustration showing another example plasma generator including a power source 120 connected to electrodes 122. A barrier 121 has the shape of a tubular nozzle, with one electrode positioned inside the nozzle and the other electrode formed as a ring around the outside of the nozzle. Sampled air can flow through the nozzle, forming plasma in a plasma volume 108. Target particles 104 can be ionized in the plasma volume. Light emitted by the ionized particles can be detected by a light detector 130.

Another example is shown in FIG. 5. In this figure, the plasma generator is a dielectric barrier plasma generator. This example also includes electrodes connected to a power source 120. In this example, electrodes are encased within two rows of cylindrical dielectric barriers 123. The dielectric barriers are inside an enclosed ionization chamber 110 with an inlet 111 and outlet 113. A sample fluid carrying target particles 104 can flow in through the inlet, through a space between the rows of dielectric barriers, and out through the outlet. Plasma can form in this space between the dielectric barriers, and the target particles can be ionized in this space. A light detector 130 is positioned to detect light emitted by the ionized particles.

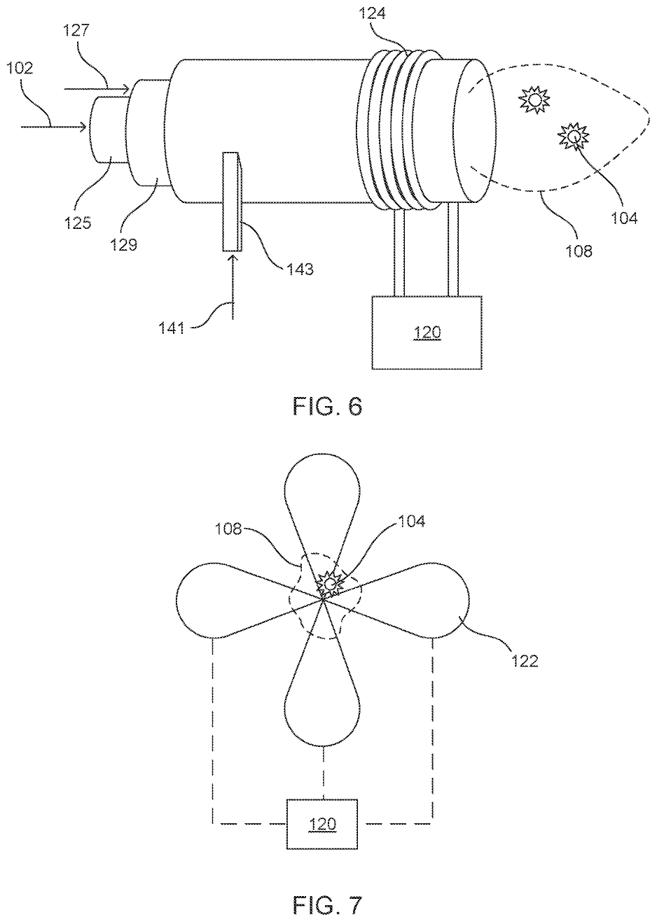

FIG. 6 shows another example of an inductively coupled plasma (ICP) generator. In this example, sampled air 102 containing the target particles 104 flows through an innermost channel 125. A discharge gas 127 can flow through an annular channel 129 around the innermost channel. A cooling gas 141 can also flow into an inlet 143 into an outermost channel. These gases can flow out from a nozzle. A wire coil 124 is positioned around the nozzle and connected to a power source 120. The wire inductively generates plasma in a plasma volume 108. Although not shown in this figure, a light detector and an ionization chamber can also be used with this plasma generator.

FIG. 7 shows an example microplasma RF device, which includes clover leaf electrodes 122 connected to an RF source 120. This device can generate plasma in a plasma volume 108 at the center of the antennas. This plasma generator can be placed within the flow path of sample air in some examples, so that target particles 104 in the air can be ionized.

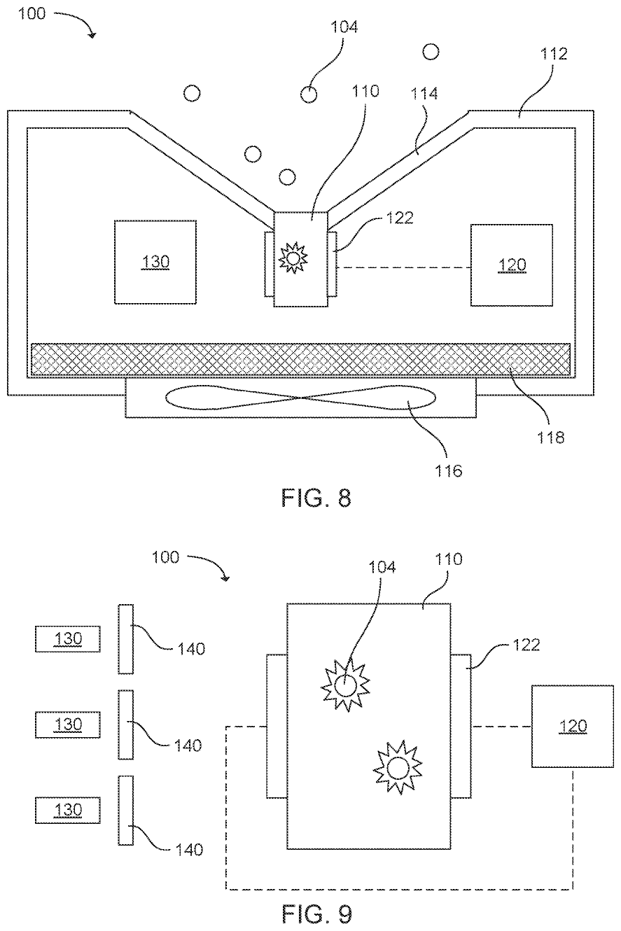

In some examples, air containing the target particles can flow through a nozzle followed by an ionization chamber. An electric field can be generated in the ionization chamber by RF, microwave or electromagnetic radiations of high frequencies in the infrared range or higher. FIG. 8 shows an example sensor 100 that is designed to continuously flow air through the sensor and monitor for a target particle. The sensor includes a housing 112 with an air inlet 114. The ambient air around the sensor contains particles 104. The sensor also includes a blower fan 116 that pull air into the housing through the air inlet. A filter 118 is located adjacent to the blower fan to clear particles from the air before the air is blown back out into the environment. As the air is pulled into the housing, the air flows into an ionization chamber 110 that contains plasma formed by electrodes 122 connected to an RF plasma generator 120. Any particles that are in the air can be ionized and at least partially decomposed. The light emissions from the ionized particles can be measured by a light sensor 130 positioned to receive the light emissions from the ionization chamber.

Sometimes when electrodes are used to generate plasma to ionize the target particles, the material of the electrodes can also contribute to the light emission that is picked up by the light sensor. In some examples, a material with a known light emission can be used for electrodes, and then the light emission spectrum produced by the electrodes can be subtracted or filtered from the spectrum measured by the light sensor In certain examples, the electrodes can be gold electrodes. Gold can have characteristic emission peaks around 669 nm, 439.5 nm, and 421.5 nm. In other examples, the electrode material can include copper, iron, or other metals. Copper electrodes can have characteristic emission peaks around 668.5 nm, 439.5 nm, and 418.5 nm. Iron can have characteristic emission peaks around 440.5 nm, 387 nm, and 537 nm. If a combination of gold and copper electrodes are used, this can produce emission peaks around 668.5 nm, 439.5 nm, and 418.5 nm. A combination of gold and iron electrodes can produce emission peaks around 668.5 nm, 439.5 nm, and 418.5 nm. A combination of copper and iron electrodes can produce emission peaks around 441 nm, 388.5 nm, and 538 nm.

In certain examples, the electrodes used to generate plasma can have a nanotextured surface that increases their effective surface area and may increase their ionization intensity and efficiency.

In further examples, other known materials that are present in the ionization chamber can also have characteristic emission spectra. These known emission spectra can also be subtracted from the spectrum measured by the light sensor. Some such materials can include oxygen, nitrogen, and water.

A suitable light sensor can be used to capture and analyze light emission from ionization and disintegration. Raman spectroscopy, or other spectroscopic techniques may be used. As particles enter the ionization chamber, they can scatter the laser light through the Raleigh process or through the Mie scattering or the inelastic Raman (Stock/anti-Stock) processes. A high-speed camera connected through a spectrometer can be used to image scattered light and its spectrum in the case of the Raman process. As the laser power is increased, the particles can be ionized and emit light before disintegration. The spectrum of the emitted light can depend on the constituents of the ionizing particles. In some examples, the laser can be used in addition to a plasma generator as described above. In further examples, a laser can be used in combination with an electric field generator that would be insufficient to form plasma on its own. However, the laser and the electric field generator together can provide sufficient energy to ionize the particles.

In some examples, the light sensor can be an optical spectrometer. A commercial spectrometer with 0.1 nm resolution can be used in some cases. In certain examples, the spectrometer can have a resolution of about 0.1 nm to about 5 nm, or from about 0.1 nm to about 1 nm, or from about 0.1 nm to about 0.5 nm. In further examples, a micro-electromechanical systems (MEMS) optical spectrometer can be used.

In certain examples, the light sensor can include a silicon photodiode array capable of detecting light wavelengths from about 400 nm to about 1100 nm. The silicon photodiode array can be capable of detecting light intensity as low as 10¹⁰ photons/cm²s. The silicon photodiode array can have a responsivity from about 0.2 to about 0.7 A/W in some examples.

Instead of using a spectrometer, in some examples, the spectrometer can be replaced by one or more photodiodes equipped with interference filters that pass light over certain bands of wavelengths. Interference filter diode arrays can be faster in certain cases and consume lower power compared to spectrometers. In one simple iteration, an interference filter (set to a specific characteristic wavelength of a virus emission, for example) can be used with a simple CCD for detection.

Optical filters can be adapted to selectively transmit a selected wavelength. The selected wavelength can be a part of the characteristic light emission from the ionized particles to be detected. For example, a given virus can emit a specific set of wavelengths when the virus is ionized, or in other words, the emission spectrum can have peaks at specific wavelengths that indicate the presence of the virus. In some examples, optical filters can be adapted to allow these specific wavelengths through the filters while blocking and/or reflecting other wavelengths. Light sensors can be located behind the optical filters, so that filtered light emitted by the ionized particles is detected by the light sensors. The light sensor can include simple light detecting photodiodes that can convert brightness of light to an electrical signal. Multiple photodiodes can be placed behind multiple optical filters to allow several specific wavelengths of light to be detected. Using these components can reduce the cost of the sensor compared to using a full optical spectrometer in the sensor.

In certain examples, the optical filters can be interference filters. These filters can reflect some bands of the spectrum while allowing other bands of the spectrum to pass through. Interference filters can be made by building up thin layers of optical coatings having different refractive indices. The interfaces between these layers can produce multiple reflections with different phases to reinforce some wavelengths of light and interfere with other wavelengths. The range of wavelengths that are allowed through the filter can be tuned by adjusting the number of layers and the thicknesses of the layers. In some cases, bandpass interference filters can be used to allow a specific band of wavelengths to pass through while reflecting other wavelengths. Other types of optical filters can also be used in alternate examples, such as absorption filters.

FIG. 9 is a schematic illustration showing an example sensor 100 that includes three optical filters 140. The optical filters are positioned between the sample and three light sensors 130a-c. The light sensors can be photodiodes that can simply produce an electric signal when any light is detected by the photodiodes. The optical filters can allow narrow bands of wavelengths through, corresponding to peaks in a characteristic spectrum of a target particle 104 to be detected. If light is detected by these photodiodes over a sufficient intensity threshold, then this can indicate that the target particle is present in the sample.

A variety of particles can be detected and identified using the sensors described herein. The particles can have a particle size from a few nanometers up to hundreds of micrometers. In some examples, the particles to be detected can have a particle size from about 3 nm to about 500 micrometers, or from about 5 nm to about 500 micrometers, or from about 10 nm to about 500 micrometers, or from about 20 nm to about 500 micrometers, or from about 50 nm to about 500 micrometers, or from about 100 nm to about 500 micrometers, or from about 200 m to about 500 micrometers, or from about 500 nm to about 500 micrometers, or from about 1 micrometer to about 500 micrometers, or from about 10 micrometers to about 500 micrometers, or from about 5 nm to about 1 micrometer, or from about 5 nm to about 500 nm, or from about 5 nm to about 200 nm, or from about 5 nm to about 100 nm.

In certain examples, the sensor can be incorporated into an air filtration system such as a HEPA air filter. It may be useful to use the sensors to monitor for dangerous material such as viruses. In one example, the sensor can differentiate between at least four different viruses. These viruses can include COVID-19, SARS, tuberculosis, influenza, or others. Viral particles in the range of 10 nm to several hundred nanometers can be detected. In other examples, bacterial particles in the size range of 1 micrometer to tens of micrometers can be detected.

The ionization fluorescence sensing technique described herein can be useful to detect very small particles, on the order of nanometers. This is much smaller than the laser wavelength (e.g. 500-1000 nm) and the ionized particles can generate their own light that can be detected by the spectrometer. These techniques can also detect small concentration of particles in the air without utilizing enhancing structures like a bow-tie antenna or sharp tips to increase the signal-to-noise ratio, such as those used in tip or surface-enhanced Raman spectroscopy.

The particle concentration in a sample measured using the sensors can range from about 1 particle/cm³ to about 1,000,000 particles/cm³ in some examples. The limit of detection (LOD), or the lowest concentration that can be recognized by the sensor, can be from about 1 particle/cm³ to about 100 particles/cm³. The lower limit of 1/cm³ is set by the minimum detectable signal of the detector while the upper limit of 100/cm³ is set by the saturation limit of the detector and can be changed by changing the ionization parameters, or from about 2 particles/cm³ to about 100 particles/cm³, or from about 5 particles/cm³ to about 100 particles/cm³, or from about 10 particles/cm³ to about 100 particles/cm³, or from about 2 particles/cm³ to about 10 particles/cm³, or from about 5 particles/cm³ to about 50 particles/cm³, in some examples.

When target particles pass through an ionization chamber in the sensors described herein, in some cases a fraction of the target particles may be ionized and another fraction may not be ionized. The fraction of total target particles that are ionized can be referred to as the ionization efficiency. In some examples, the ionization efficiency can be from about 0.3 to about 0.99, or from about 0.4 to about 0.99, or from about 0.5 to about 0.99, or from about 0.5 to about 0.8, or from about 0.5 to about 0.7, or from about 0.4 to about 0.6.

The particles can be in a fluid sample. The fluid can include gas, liquid, or a combination thereof. In certain examples, the fluid can include water, saliva, air, or a combination thereof.

Some particles may be present at a concentration that is lower than a limit of detection of the sensor. Some viruses can be dangerous even when present in air or water at such low concentrations. In certain examples, the sensors described herein can include a concentrator adapted to concentrate the fluid sample before the fluid sample is ionized. As used herein, concentrating the fluid sample refers to increasing the number of target particles in a given volume of fluid to make it easier to detect the particles. In-line particle concentrators can be used to accumulate particles to detectable levels that can range between 10 and 1,000 micrograms/m³. Depending on air handler throughput, the concentration stage may take up to 10 to 20 seconds. The air can then be passed through the ionization chamber to partially or fully ionize the particles. The light emitted by the ionized particles is analyzed to identify them based on their emission bands. The strength of emission in these bands is used to estimate their concentrations.

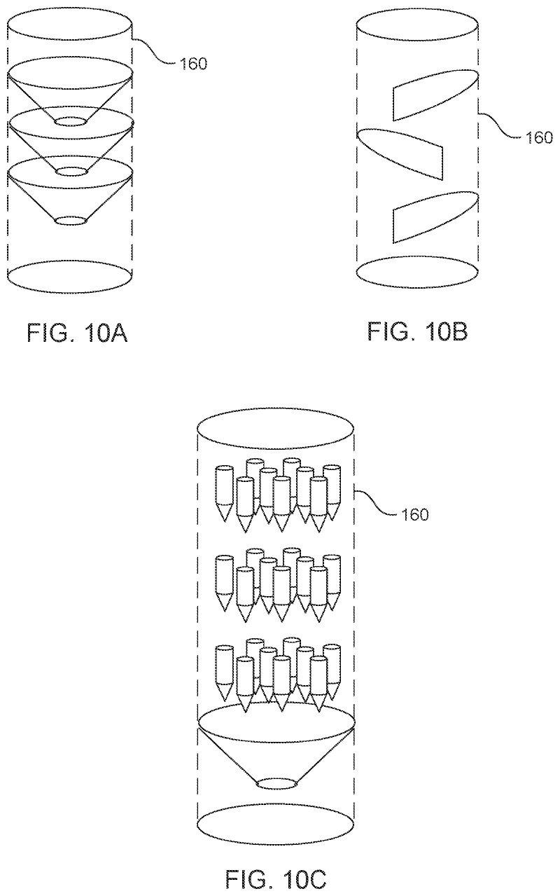

The concentrator can include any type of concentrator capable of increasing the number of solid particles in a volume of air, water, or other fluid. In some examples, the concentrator can be a spiral concentrator. Other example concentrators 160 can have a design shown in FIGS. 10A, 10B, and 10C. These concentrators can utilize particle momentum to direct the motion of particles in certain directions and extract them from the air. After a sufficient concentration of particles has been captured by the concentrator, the particles can be ionized to detect target particles as explained above. For example, cyclone, electrostatic/magnetostatic, and filter-based concentrators among other techniques can be used to concentrate particles within or prior to detection by the sensor.

In further examples, the sensor can include one or more filters to remove particles of specified size ranges from the air or other fluid samples. This can be useful to remove particles that are known to be significantly smaller or larger than the target particles. After filtering out particles of the wrong sizes, the remaining particles can be more likely to include target particles without as many other particles which can make it more difficult to detect the target particles. For example, SARS-CoV-2 virus range in size from 70 nm up to ~150 nm while dust particles can go up to 100s of micrometers. A filter in this case can be used to remove larger than 0.5 micrometer particles to prevent saturation of the spectrometer detector from ionization light of larger particles.

As mentioned above, the sensor for detecting particles can include an ionization chamber. The ionization chamber can be adapted to accept a fluid sample so that the fluid sample can be tested for target particles. In some examples, the ionization chamber can be any fully enclosed or partially enclosed volume that can accommodate a fluid sample. The fluid sample can be held stationary within the ionization chamber in some examples, while in other examples the fluid sample can move in or through the ionization chamber. For example, a sensor can include an ionization chamber shaped as a tube through which a continuous stream of air can flow. This arrangement can be used to test a large volume of air by flowing the air continuously through the ionization chamber. In other examples, the ionization chamber can include a liquid container adapted to contain a liquid sample, such as water or saliva. The liquid sample in the container can be analyzed as a single batch, i.e., not as a continuous flow of liquid. In some such examples, the liquid sample can be stationary inside the container, while in other examples the liquid sample can be stirred or mixed while the sensor is used to test the sample for target particles.

In examples that include a flowing sample, such as a continuous flow of air, the particles can be in motion while the particles are ionized and detected. The speed of the particles can depend on the flow velocity of the air or other fluid in which the particles are entrained. In some examples, the particles can have a velocity from about 1 cm/s to about 1,000 cm/s while the particles are being detected. In other examples, the velocity can be from about 10 cm/s to about 1,000 cm/s, or from about 100 cm/s to about 1,000 cm/s, or from about 10 cm/s to about 500 cm/s, or from about 10 cm/s to about 100 cm/s.

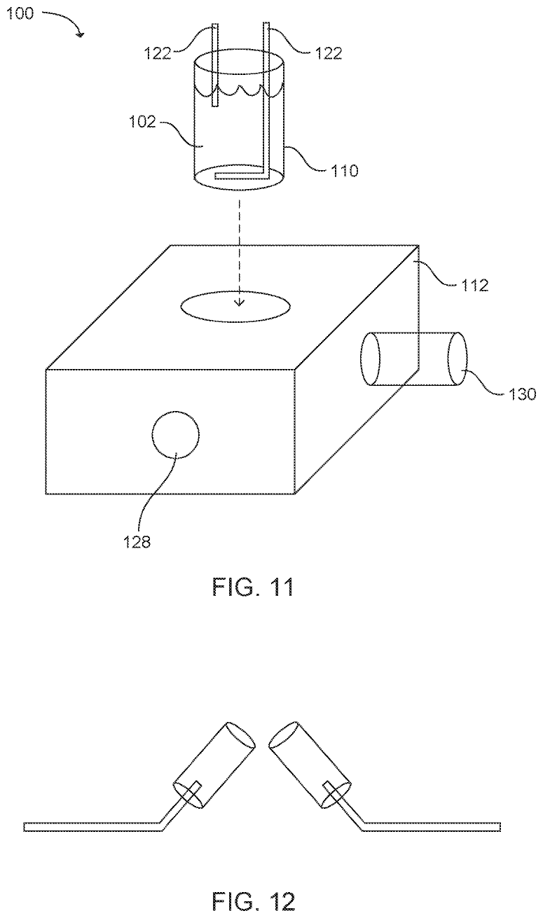

FIG. 11 shows a perspective view of an example sensor 100 that includes an ionization chamber 110 that is a liquid container. This liquid container can hold a liquid sample 102 of water, saliva, or other liquid that may include target particles. Two electrodes 122 are located inside the container to contact the liquid sample. The electrodes can be connected to an electrical power source, such as an RF source (not shown). The liquid container and assembly can be lowered into a housing 112, where the sample can be aligned with a laser 128 that can add additional energy to the sample to ionize the target particles. The sample can also be aligned with a fiber optic spectrometer 130 that can be used to measure the light emission from the ionized sample.

In another example, the ionization chamber can include one or more capillary tubes that can hold a liquid sample. In a certain example, two capillary tubes can contain the liquid sample and each of the two capillary tubes can be connected to electrodes. A gap can be between the two capillary tubes. When a voltage is applied across the electrodes, plasma can form in the gap between the capillary tubes. Plasma can ionize particles present in the liquid sample. FIG. 12 shows an example of this design, with two capillary tubes 150 that are connected to electrodes 122. The liquid sample 102 is held inside both capillary tubes, with a gap 152 between the capillary tubes. Plasma can form in this gap when an electric voltage is applied to the electrodes.

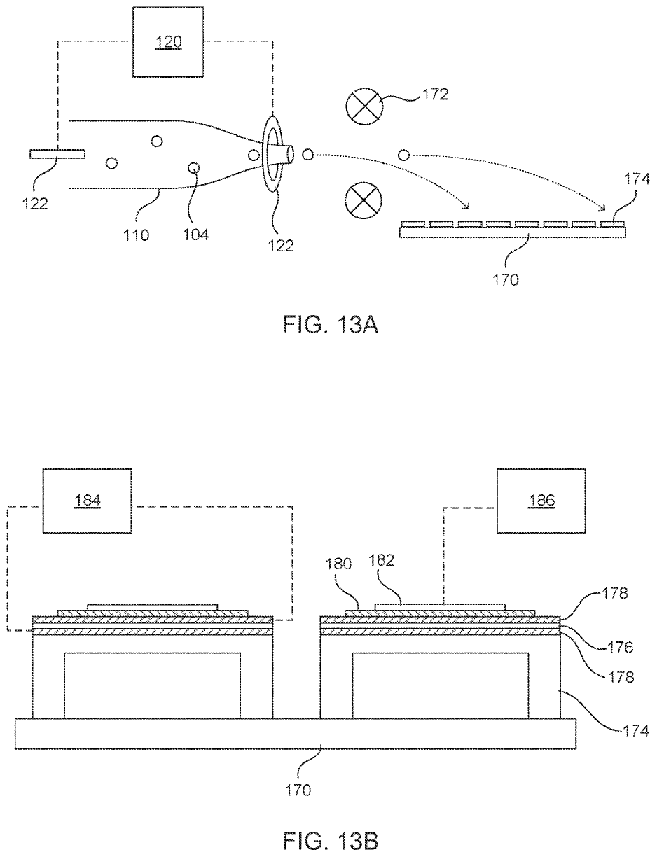

In further examples, the measurement of light emissions using an optical spectrometer or other light detector can be supplemented with a micro-electro-mechanical system (MEMS) ion trap mass spectroscopy method to increase the sensitivity of the sensor, the resolution (to differentiate between different particles), and dynamic range. The MEMS mass spectrometer can be used in combination with the ionization chambers and light sensors described herein. FIG. 13A shows a schematic view of an example MEMS mass spectrometer 170. Particles 104 are charged in an ionization chamber 110 by electrodes 122 connected to an electric field source 120. Ionized charged species 106 produced in the ionization chamber of the sensor can be directed through a region with a constant magnetic field 172 (the magnetic field in the direction into the page is represented as circles with an X-cross in the center of the circles). The Lorentz force ~qvxB causes ionized particles of different velocities and charge content to deflect by different amounts resulting in their separation into different bins 174. Bins are equipped with their own charge and mass detectors that provide output to allow the identity of the particles to be determined. Particles with the same charge to mass ratios (q/m) will end up in the same bin. Note that particles with similar mass ratios may end up in a common bin depending on a given resolution range for the bin size. Thus, it can be desirable to design the bin size to correspond to a desired degree of resolution between particles of similar mass ratios (i.e. smaller bin size corresponds with higher resolution).

With the utilization of MEMS microbalance sensors, the mass and charge content of the particles can be measured separately. For example, N57 rare earth magnets can produce uniform 500-900 mT magnetic fields over 1 cm² areas in a 5 mm gap region. Taking SARS-CoV2 as an example, the virus spiking proteins can be fragmented easily in the plasma ionization process leading to S1 and S2 spiking protein segments around 5-12 nm long. Assuming that these segments are around m~1.6×10⁻²⁰ g and carry just one positive charge (q~1.6×10⁻¹⁹ Coulomb), their trajectory with an initial velocity of V~0.1 m/s in B=1 T is around r=(m/q)V/B~10 mm. The velocity and the magnetic field can be varied to enable realization of a compact system. Such a MEMS microbalance array 170 is shown in FIG. 13B. In this example, each bin 174 is equipped with a doubly clamped beam with a layer of AlN piezoelectric actuator 176 that is used to actuate and vibrate the beam at ~15 kHz. Platinum layers 178 are on top and underneath the AlN layer. A layer of Si₃N₄ 180 and a gold layer 182 are positioned over the upper platinum layer. The platinum layers can be electrically connected to an electric power source 184 to provide power to the AlN piezoelectric layer. The gold layer of each bin in this example can be electrically connected to an electrometer 186 to measure the charge of particles that contact the bin.

A plasma ionization sensor with an optical spectrometer having a 0.1 nm wavelength resolution can detect all the variants of these example viruses since their emission bands are very close to each other. MEMS ion trap mass spectroscopy method can be added to differentiate between different variants. In most cases, it is desirable to be able to detect all variants as one virus. Neither of these techniques use molecular tags such as aptamers or antibody/antigens. These sensors can be reprogramed quickly to detect variants. Furthermore, this approach is label-free and can be free of the use of analytes.

In further examples, the sensors can be programmable in real-time for other emergent viruses. The system output can be displayed on an OLED and wirelessly transmitted to smart phones and central monitoring systems for real-time monitoring of the viral particles in homes, buildings, and in different city locations.

### EXAMPLES

### Example 1

The ability of the plasma ionization for detecting different liquids was demonstrated using liquids such as acetone, isopropyl alcohol, water, uninfected saliva and COVID-19 infected saliva. A source of ionization (energy source) is used to ionize molecules or particles near a liquid surface that can be electrophoretically pulled out of the liquid before ionization. Alternatively, ultrasonication or a nebulizer can be used to produce a spray of the liquid and its content into an ionization chamber. The ionization can be affected by many different techniques such as x-ray, UV, electron beam, large DC fields, RF fields, flame, and even by frictional rubbing.

Excitation and ionization of materials can lead to oxidation/reduction reactions with nearby substances and gases (molecules). In the case of viral and other extended particles, the excitation process can have many different stages involving 1) evaporation of their surface moisture, 2) decomposition of their surface proteins, or in the case of COVID-19 detachments of its spiking proteins, 3) decomposition of their internal macro-molecules such as DNA or RNA, and finally, 4) ionization of these different components. At some of these ionization and dissociation stages there can be luminescence that can be detected to identify the excitation and decomposition process.

Experiments were carried out using a sensor having a ionization chamber shaped as a liquid container with one electrode at the bottom of the container and one electrode positioned above the surface of a liquid sample. Large voltages (1000-5000 V) are applied between the top and bottom electrodes and the molecules on the liquid surface are exposed to large polarizing fields. If these fields become sufficiently large (such as about 10⁴ to 10⁵ V/cm), the liquid surface molecules can be ionized. In aqueous solutions, water molecules dominate with H—O bond energy of 5.15 eV. Under intense electric field water evaporates and increases the effective dielectric constant of the air. Other ions in the solution such as Na+ and Cl− can also be ionized and detected through their light emission. Larger molecules involving proteins, DNA and other macromolecules will be subject to electrostatic forces and may wander close enough to the liquid surface to be subject to strong dissociating and ionizing fields. In the case of COVID-19 viruses, the dissociation may occur in the form of detaching its spiking proteins followed by its fragmentation. Most of the bonds in these excitations are covalent bonds between carbon, hydrogen, and oxygen atoms. Electric dipole interaction is the primary mechanism of electric field ionization of molecules and fragmentation of particles, other extended particles, and their subsequent ionization. While polar molecules readily orient themselves with the external electric field, non-polar molecules become polarized first by the fast response of their electronic orbitals. Particles and extended objects also acquire residual charges and polarization before fragmentation and then ionization. The electrodes can optionally include nanotexturing to enhance spectral lines.

Field ionization can also be used to detect airborne viral and other particles. The density of airborne particles is lower than in the liquid phase. Therefore, in some cases concentrators and photomultipliers can be used in detecting the electroluminescent/fluorescent/emission spectra.

The contribution of gold electrodes to the emission spectra was determined by measuring a light emission of gold alone. Gold (24 carat) has a prominent emission at 669 nm that also shows up in liquid spectra discussed later. Table I summarizes prominent peaks were detected in gold and other common electrodes. Iron has a prominent emission at 440.5 nm. Copper has an emission spectrum that closely resembles gold with a prominent emission at 668.5 but has higher intensity at 418.5 nm and a lower intensity at 537.5 nm.

TABLE I
Tabulated results of emission spectra
peaks of different electrode materials.

| | | 2nd Most | 3rd Most |
|---|---|---|---|
| | 1^{st} Most | Prominent | Prominent |
| | Prominent | Peak* | Peak* |
| | Peak* | λ (Normalized | λ (Normalized |
| Electrode | λ (Normalized | height = | height = |
| Materials | height = 1.0) | 0.75-0.40) | 0.50-0.30) |
| Au—Au | 669.0 | 439.5 | 421.5 |
| Cu—Cu | 668.5 | 439.5 | 418.5 |
| Fe—Fe | 440.5 | 387 | 537 |
| Au—Cu | 668.5 | 439.5 | 418.5 |
| Au—Fe | 668.5 | 439.5 | 418.5 |
| Cu—Fe | 441 | 388.5 | 538 |

*Refers to n-th most prominent peak between 300 and 900 nm.

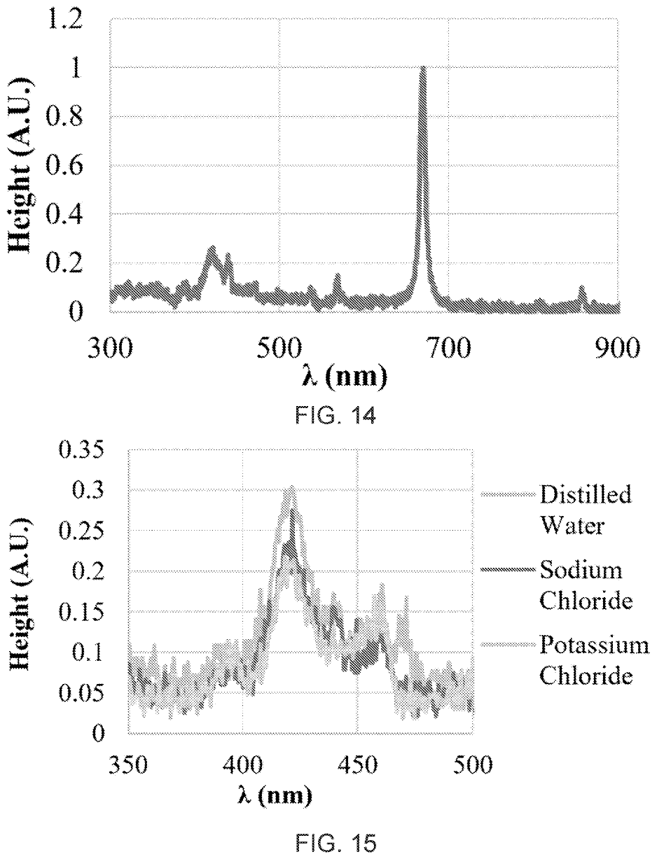

The electrode emission spectrum contributes to the emission spectra of other substances that were ionized to identify. These electrode emission spectra can be accounted for when identifying other substances. Another important substance present in most materials of interest is water. FIG. 14 shows the emission spectrum of water ionized using gold electrodes Gold's characteristic peak is still visible around the 669 nm and the effect of the water can be seen in the 400-600 nm range.

FIG. 15 shows the emission spectrum of sodium chloride, potassium chloride, and sodium chloride all ionized with gold electrodes. The difference between the emission spectra of pure water and aqueous sodium chloride are seen in the 400-500 nm range as shown in FIG. 15.

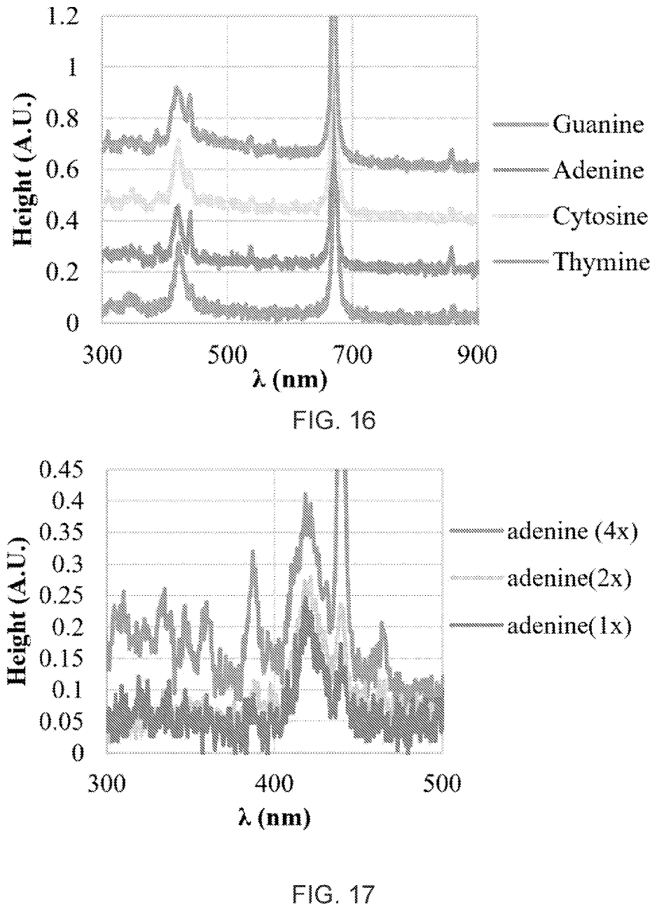

Other organic analytes such as deoxyribonucleic acid (DNA) bases can also be ionized and identified through their emission spectra. FIG. 16 shows the emission spectra of the DNA bases adenine, guanine, cytosine and thymine. In these experiments 1 mm³ (0.0025 g) of DNA bases powder were dissolved and ultrasonicated in 1 mL of water and the ionization cell was equipped with gold electrodes.

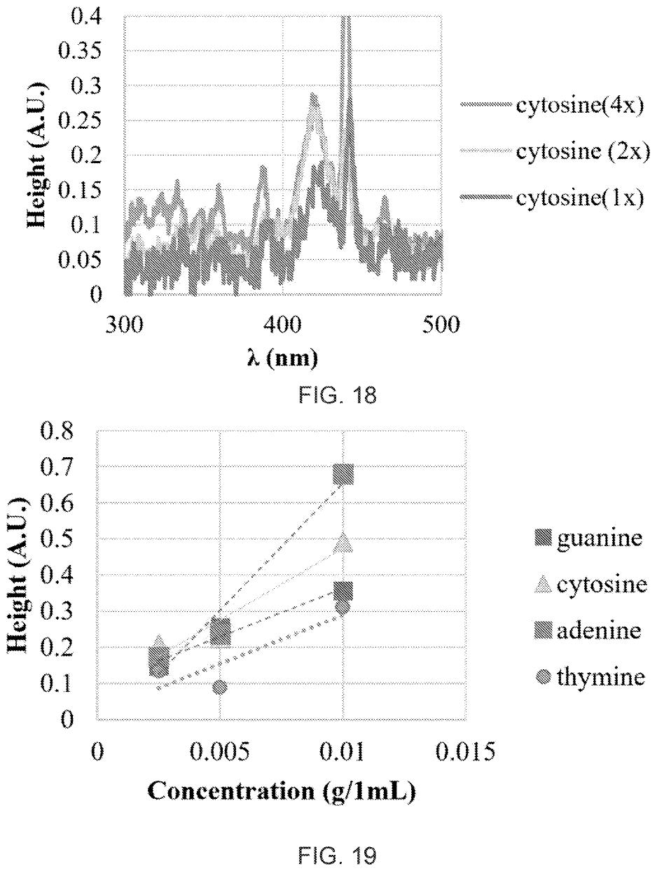

While gold emission spectrum contributes strongly to the spectra shown in FIG. 16, different DNA bases can still be distinguished from each other. FIGS. 17 and 18 show the differences between varying concentrations of adenine and cytosine.

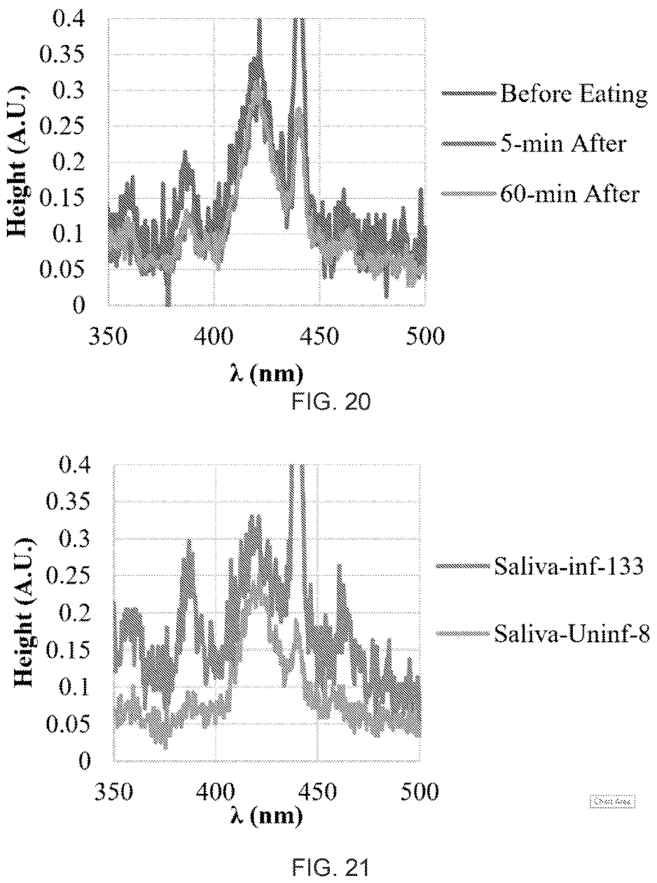

FIG. 19 shows the peak emission values at 439.5 for adenine, 440.5 for cytosine and thymine, and 421.5 for guanine at different concentrations. The average sensitivity was ~20%/g. FIG. 20 shows the emission spectra response of fresh saliva in the same individual before and after a meal that is quite significant.

FIG. 21 shows the emission spectra of uninfected and SARS-CoV2 infected saliva. The emission spectrum of the uninfected saliva is similar to the emission spectrum shown in FIG. 20 of a different uninfected individual. There are two peaks one at 425 nm and the other at 460 nm that are uniquely observed in the infected saliva.

These results show that a miniaturized sensor system as described herein can be used to detect the SARS-CoV2 virus in saliva. This is strong evidence that the sensors can also be used to detect other viral particles.

The experimental setup disclosed herein can be miniaturized. As an ionization source, a small 1-100 mm microfabricated plasma device can be used. The spectrometer can also be miniaturized using MEMS approaches. Interference filters can also be implemented readily in waveguides as well as in free-space formats. Optical detectors sensitive in the 300 nm to 900 nm can be made with silicon. A miniaturized plasma ionization sensor can also be prepared.

This plasma ionization detection system can be used as a separate sensor or as an integrated system with a fan, concentrator, exit HEPA filter, and/or other components. Viruses can be introduced and tested using a nebulizer to introduce viruses near the sensor with a known, quantifiable concentration. The characteristic light emission spectrum of the viruses can then be recorded and used to correlate future samples when detecting the viruses.

### Example 2

A sensor was built using the design shown in FIG. 11. The ionization chamber included a vial having two gold electrodes contacting saliva. As components of the saliva are dissociated and then ionized, a 780 nm laser diode can be used with a fiber spectrometer to capture spectral information of the decomposed components.

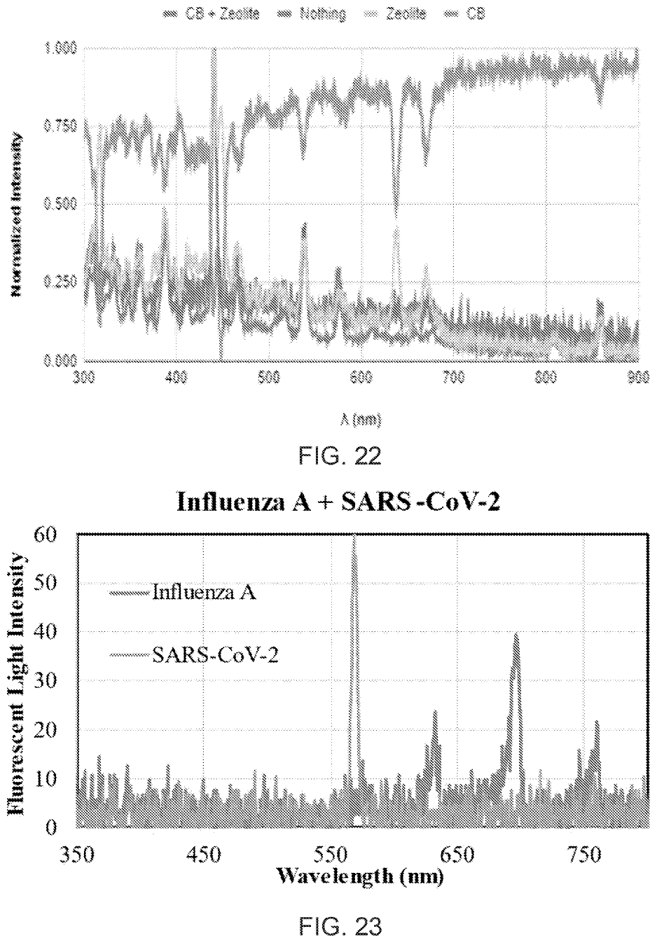

FIG. 22 shows spectra measured from ionizing several airborne inorganic particles, including carbon black (CB), zeolite, CB plus zeolite, and the sensor without any particles in the air.

FIG. 23 shows spectra measured from ionizing influenza A and SARS-CoV-2. These two viruses had different peaks. This demonstrates that the sensors described herein can be used to differentiate between these viruses.

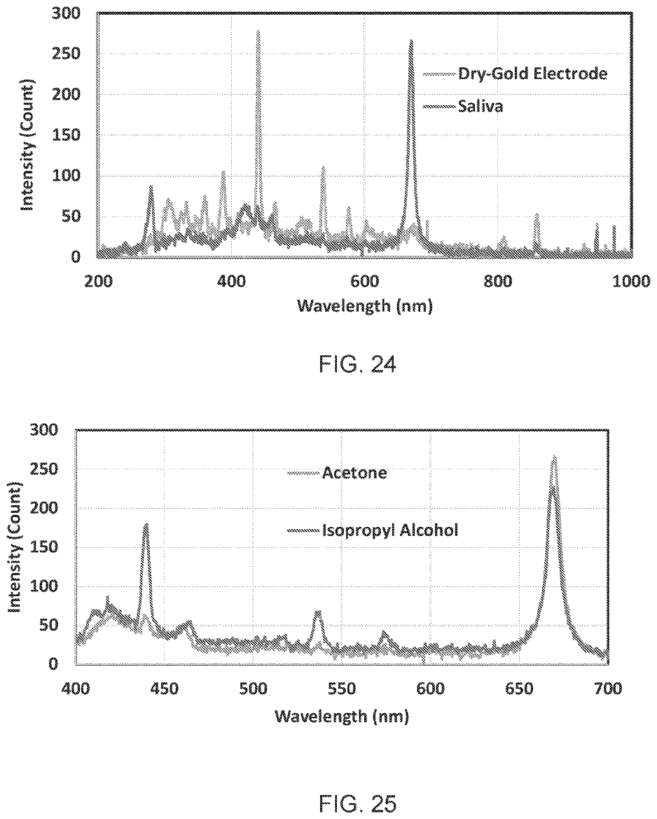

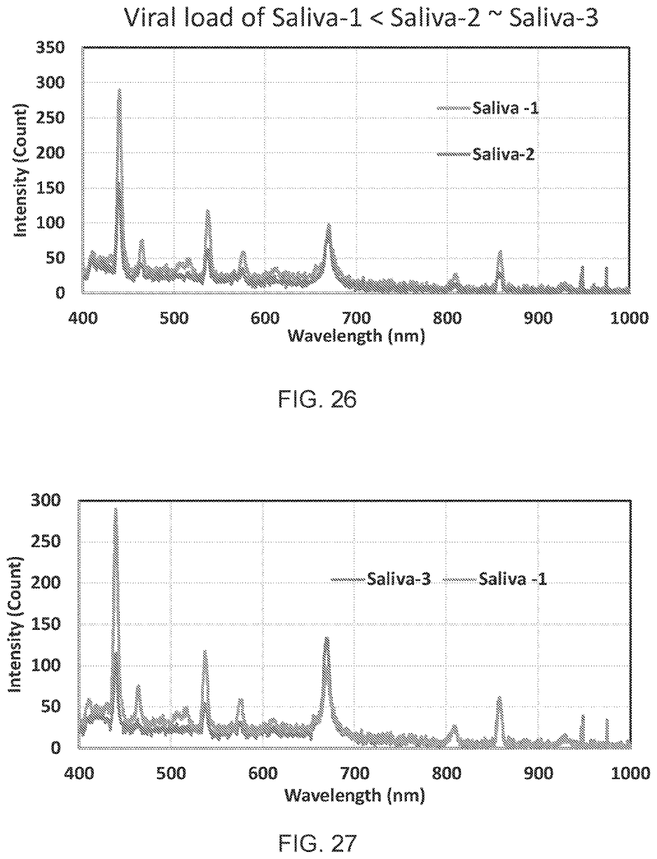

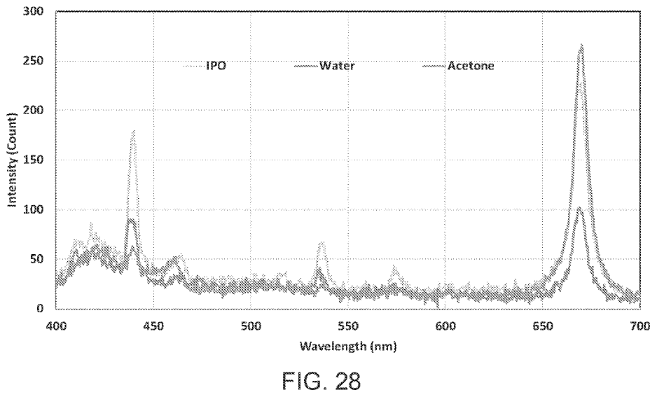

FIGS. 24-28 show electroluminescence emission spectra comparing dry electrodes, saliva samples, acetone, and isopropyl alcohol.

### Example Clauses

For purposes of clarity, additional variations of the sensors and particle detection methods can include.

Clause 1. A sensor for detecting a particle, comprising:
an ionization chamber adapted to accept a fluid sample comprising a particle to be detected;
an energy source adapted to provide sufficient energy to the particle to ionize the particle and at least partially decompose the particle; and
a light sensor adapted to detect a characteristic light emission from the ionized particle.

Clause 2. The sensor of any clause, wherein the energy is sufficient to fully decompose the particle.

Clause 3 The sensor of any clause, wherein the particle is a virus, a bacterium, a pathogen, or a combination thereof.

Clause 4. The sensor of any clause, wherein the energy source comprises a radio frequency (RF) source, a microwave source, a direct current (DC) source, an alternating current (AC) source, a plasma generator, a high-frequency electromagnetic source, an ultraviolet (UV) source, an X-ray source, a laser, a flame, an electron beam, or a combination thereof.

Clause 5. The sensor of any clause, wherein the energy source comprises a plasma generator.

Clause 6. The sensor of any clause, wherein the plasma generator is configured to generate oxygen plasma, nitrogen plasma, or a combination thereof.

Clause 7. The sensor of any clause, wherein the energy source is adapted to create an electric field density greater than about 10⁵ V/cm within the ionization chamber.

Clause 8. The sensor of any clause, wherein the energy source comprises electrodes having a nanotextured surface.

Clause 9. The sensor of any clause, wherein the light sensor comprises an optical spectrometer.

Clause 10. The sensor of clause 9, wherein the optical spectrometer measures wavelengths in a range from about 300 nm to about 900 nm.

Clause 11. The sensor of any clause, wherein the light sensor comprises one or more optical filters adapted to selectively transmit a selected wavelength, wherein the characteristic light emission from the ionized particle comprises the selected wavelength.

Clause 12. The sensor of any clause, further comprising a concentrator adapted to concentrate the fluid sample before the fluid sample is ionized.

Clause 13. The sensor of any clause, wherein the fluid sample comprises air and airborne solids, water and waterborne solids, saliva, a bodily fluid, or a combination thereof.

Clause 14. The sensor of any clause, further comprising a micro-electromechanical mass spectrometer configured to separate ionized components of decomposed particles by a charge to mass ratio. Alternatively, an optical micro-electromechanical mass spectrometer can be used.

Clause 15. The sensor of any clause, further comprising one or more filters configured to filter out particles of a selected size range before the fluid sample is ionized.

Clause 16. A method of detecting a particle, comprising.
applying energy to a fluid sample comprising a particle to be detected, wherein the energy is sufficient to ionize the particle and at least partially decompose the particle;
detecting a light emission from the ionized particle;
correlating the detected light emission with a characteristic light emission of the particle; and
indicating the presence of the particle in the fluid sample.

Clause 17. The method of any clause, wherein applying the energy comprises applying a plasma, applying an electric field, applying radio frequency (RF) energy, applying microwaves, applying direct current (DC), applying alternating current (AC), applying high-frequency electromagnetic energy, applying ultraviolet (UV) energy, applying X-rays, applying laser energy, applying a flame, applying an electron beam, or a combination thereof.

Clause 18. The method of any clause, wherein the particle is fully decomposed.

Clause 19. The method of any clause, wherein the particle is a virus, a bacterium, a pathogen, or a combination thereof.

Clause 20. The method of any clause, further comprising concentrating the fluid sample before applying the energy to the fluid sample.

Clause 21. The method of any clause, wherein the fluid sample comprises air and airborne solids, water and waterborne solids, saliva, a bodily fluid, or a combination thereof.

Clause 22. The method of any clause, wherein detecting the light emission from the ionized particle comprises filtering the light emission from the ionized particle using one or more optical filters adapted to selectively transmit a selected wavelength and then detecting the selected wavelength, wherein the characteristic light emission of the particle comprises the selected wavelength.

Clause 23. The method of any clause, further comprising using a filter to filter out particles of a selected size range before applying the energy to the fluid sample.

While the flowcharts presented for this technology may imply a specific order of execution, the order of execution may differ from what is illustrated. For example, the order of two more blocks may be rearranged relative to the order shown. Further, two or more blocks shown in succession may be executed in parallel or with partial parallelization. In some configurations, one or more blocks shown in the flow chart may be omitted or skipped. Any number of counters, state variables, warning semaphores, or messages might be added to the logical flow for purposes of enhanced utility, accounting, performance, measurement, troubleshooting or for similar reasons.

The devices described herein may also contain communication connections or networking apparatus and networking connections that allow the devices to communicate with other devices. Communication connections are an example of communication media. Communication media typically embodies computer readable instructions, data structures, program modules and other data in a modulated data signal such as a carrier wave or other transport mechanism and includes any information delivery media. A “modulated data signal” means a signal that has one or more of its characteristics set or changed in such a manner as to encode information in the signal. By way of example and not limitation, communication media includes wired media such as a wired network or direct-wired connection and wireless media such as acoustic, radio frequency, infrared and other wireless media. The term computer readable media as used herein includes communication media.

Reference was made to the examples illustrated in the drawings and specific language was used herein to describe the same. It will nevertheless be understood that no limitation of the scope of the technology is thereby intended. Alterations and further modifications of the features illustrated herein and additional applications of the examples as illustrated herein are to be considered within the scope of the description.

Furthermore, the described features, structures, or characteristics may be combined in any suitable manner in one or more examples. In the preceding description, numerous specific details were provided, such as examples of various configurations to provide a thorough understanding of examples of the described technology. It will be recognized, however, that the technology may be practiced without one or more of the specific details, or with other methods, components, devices, etc. In other instances, well-known structures or operations are not shown or described in detail to avoid obscuring aspects of the technology.

Although the subject matter has been described in language specific to structural features and/or operations, it is to be understood that the subject matter defined in the appended claims is not necessarily limited to the specific features and operations described above. Rather, the specific features and acts described above are disclosed as example forms of implementing the claims. Numerous modifications and alternative arrangements may be devised without departing from the spirit and scope of the described technology.

What is claimed is:

1. A sensor for detecting a particle, comprising:
an ionization chamber adapted to accept a fluid sample comprising a particle to be detected;
an energy source adapted to provide sufficient energy to the particle to ionize the particle and at least partially decompose the particle; and
a light sensor adapted to detect a characteristic light emission from the ionized particle.

2. The sensor of claim 1, wherein the energy is sufficient to fully decompose the particle.

3. The sensor of claim 1, wherein the particle is a virus, a bacterium, a pathogen, or a combination thereof.

4. The sensor of claim 1, wherein the energy source comprises a radio frequency (RF) source, a microwave source, a direct current (DC) source, an alternating current (AC) source, a plasma generator, a high-frequency electromagnetic source, an ultraviolet (UV) source, an X-ray source, a laser, a flame, an electron beam, or a combination thereof.

5. The sensor of claim 1, wherein the energy source comprises a plasma generator.

6. The sensor of claim 5, wherein the plasma generator is configured to generate oxygen plasma, nitrogen plasma, or a combination thereof.

7. The sensor of claim 1, wherein the energy source is adapted to create an electric field density greater than about 10⁵ V/cm within the ionization chamber.

8. The sensor of claim 1, wherein the energy source comprises electrodes having a nanotextured surface.

9. The sensor of claim 1, wherein the light sensor comprises an optical spectrometer.

10. The sensor of claim 9, wherein the optical spectrometer measures wavelengths in a range from about 300 nm to about 900 nm.

11. The sensor of claim 1, wherein the light sensor comprises one or more optical filters adapted to selectively transmit a selected wavelength, wherein the characteristic light emission from the ionized particle comprises the selected wavelength.

12. The sensor of claim 1, further comprising a concentrator adapted to concentrate the fluid sample before the fluid sample is ionized.

13. The sensor of claim 1, wherein the fluid sample comprises air and airborne solids, water and waterborne solids, saliva, a bodily fluid, or a combination thereof.

14. The sensor of claim 1, further comprising a micro-electromechanical mass spectrometer configured to separate ionized components of decomposed particles by a charge to mass ratio.

15. The sensor of claim 1, further comprising one or more filters configured to filter out particles of a selected size range before the fluid sample is ionized.

16. A method of detecting a particle, comprising:
applying energy to a fluid sample comprising a particle to be detected, wherein the energy is sufficient to ionize the particle and at least partially decompose the particle;
detecting a light emission from the ionized particle;
correlating the detected light emission with a characteristic light emission of the particle, and
indicating presence of the particle in the fluid sample.

17. The method of claim 16, wherein applying the energy comprises applying a plasma, applying an electric field, applying radio frequency (RF) energy, applying microwaves, applying direct current (DC), applying alternating current (AC), applying high-frequency electromagnetic energy, applying ultraviolet (UV) energy, applying X-rays, applying laser energy, applying a flame, applying an electron beam, or a combination thereof.

18. The method of claim 16, wherein the particle is fully decomposed.

19. The method of claim 16, wherein the particle is a virus, a bacterium, a pathogen, or a combination thereof.

20. The method of claim 16, further comprising concentrating the fluid sample before applying the energy to the fluid sample.

21. The method of claim 16, wherein the fluid sample comprises air and airborne solids, water and waterborne solids, saliva, a bodily fluid, or a combination thereof.

22. The method of claim 16, wherein detecting the light emission from the ionized particle comprises filtering the light emission from the ionized particle using one or more optical filters adapted to selectively transmit a selected wavelength and then detecting the selected wavelength, wherein the characteristic light emission of the particle comprises the selected wavelength.

23. The method of claim 16, further comprising using a filter to filter out particles of a selected size range before applying the energy to the fluid sample.
